(19) United States
(12) Patent Application Publication
(10) Pub. No.: US 2003/0210968 A1
(43) Pub. Date: Nov. 13, 2003

(54) Fastener assembly

(76) Inventors: Harold Miyamura, San Jose, CA (US); Guy William Gladden, Santa Clara, CA (US); Donald Gin Wong, San Mateo, CA (US)

Correspondence Address: HEWLETT-PACKARD COMPANY, Intellectual Property Administration, P.O. Box 272400, Fort Collins, CO, 80527-2400, US

(21) Appl. No.: 10/144,584

(22) Filed: May 13, 2002

(51) Int. Cl. F16B 21/18

(52) U.S. Cl. 411/352

(57) ABSTRACT

A fastener assembly provides an adjustable restrained connection between a fastener and a retainer. The assembly connects to a support member and connects the support member to a component.

### BACKGROUND

Electrical components such as computer components and circuit boards are held together by support members. The connections between the components and support members are sometimes made by using fastener assemblies.

Some existing fastener assemblies use a combination of threaded screws and washers that are not in a captive connection to the components or support members and, if not handled properly, are subject to shorting out the components during installation and removal. Portions of fastener assemblies that fall into the components may damage the components and increase the assembly time, and thus increase production cost.

Some fastener assemblies include a threaded screw fastened to both the support member and the component with the screw unable to move relative to the support member. In this arrangement, stripping of the threads in the component can occur during the process of removing the screw. If the screw cannot retract relative to the component, the screw threads can possibly strip the threads of the support member and the component. In arrangements where the screw is inflexibly attached to the support member, care must be taken to assure that the threaded elements inflexibly attached to the support member are removed in a prescribed sequence in order to avoid thread stripping in the component. Following such procedures increases the assembly time in mass production.

### DESCRIPTION OF THE DRAWINGS

Features and aspects of the invention will become apparent from the description, claims, and accompanying drawings in which:

FIG. 1 is top perspective view of an example an apparatus of the invention;

FIG. 2 is a bottom perspective view of an example of an apparatus of the invention;

FIG. 3 is a side view of an example of an apparatus of the invention;

FIGS. 4 and 5 are a perspective and a partially cut away side view, respectively, of an example of an apparatus of the invention connected to a support member;

FIG. 6 is an exploded view of an example of an apparatus of the invention connected to a support member;

FIG. 7 is a partial sectional view of an example of the apparatus of the invention positioned to connect the support member to a component;

FIG. 8 is a partial sectional view of an example of the apparatus of the invention securing the support member to the component;

FIG. 9 is a partial sectional view of an example of the apparatus of the invention showing a partial retraction of the screw form the component; and

FIG. 10 is a perspective view of an example of the apparatus of the invention showing multiple connections of the support member and the component.

### DETAILED DESCRIPTION

Examples of apparatuses in accordance with the invention are disclosed herein. These are examples and those skilled in the art will appreciate and understand the modifications and variations of the structure, methods and operation of apparatuses that are in accordance with the invention.

The apparatus 100 connects support members and components in the assembly of products, such as electrical products. Examples of such electrical products are circuit boards and computer components. Applications of the apparatus 100 are not limited to electrical products. The apparatus 100 has application where a safe, efficient, cost effective way of assembling and connecting members of a structure is needed. Further, the apparatus 100 has application where a location of connection between two members may be subject to forces tending to move the members away from each other at the location of connection. The movement of the members away from each other may result in the stripping of threaded connectors such as a screw connected with a threaded aperture that holds the members together. This is particularly true during assembly and disassembly of connecting the members when a reduced thread contact between the connectors is present.

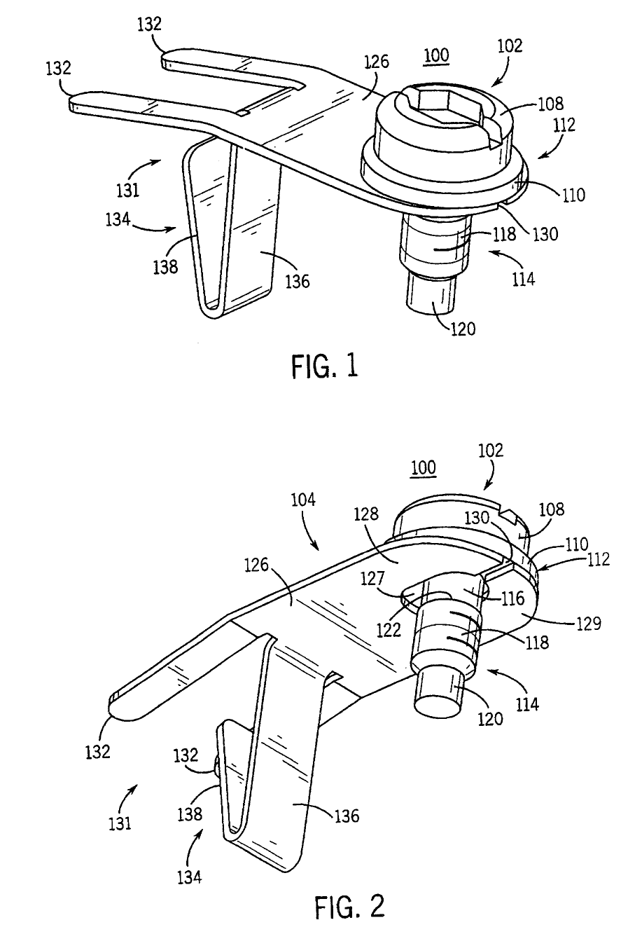

Referring to FIGS. 1 and 2, an example of an apparatus 100 is shown that comprises a screw 102 and washer 104 with the screw 102 in a restrained and adjustable relationship with the washer 104. Those skilled in the art will understand that variations of the screw 102 will include other fasteners such as bolts, clamps, pins, spring loaded mechanisms, etc., and that variations of the washer 104 will include retainers, clips, snaps, buckles, clasps, etc.

The screw 102 comprises a head 106 with a recess 108 suitable for receiving a tool for turning the screw 102 during an installation process. A crest cup washer 110 is located at a base 112 of the screw 102. A barrel portion 114 of the screw 102 extends from the base 112. The barrel portion 114 comprises an unthreaded portion 116, a helically threaded portion 118 and an unthreaded lead-in portion 120. An end of the threaded portion 114 comprises a shoulder 122 at the interface with the unthreaded portion 116.

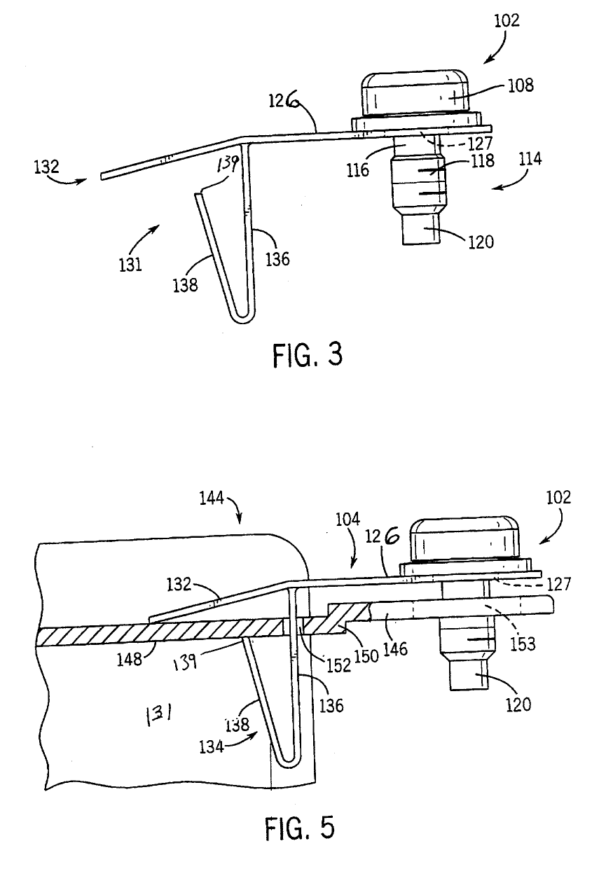

The washer 104 comprises a flat portion 126 having an elongated slot 127 having two opposed side members 128 and 129 and a channel 130 connecting the elongated slot 127 through an edge of the flat portion 126. Referring also to FIG. 3, a restraining member 131 of the washer 104 restrains the washer 104 to the support member 144. An example of a restraining member 131, includes tabs 132 extending at an acute angle from the flat portion 126 and a clip such as a generally v-shaped member 134 extending away from the flat portion 126. The v-shaped member 134 comprises a first portion 136 connected to the flat portion 126 and a second portion 138 extending from a connection with the first portion 136 toward the tabs 132. The tabs 132 are positioned at opposed sides of the v-shaped member 134. The v-shaped member 134 and the tabs 132 have a restraining relationship with the support member 144. In one example, the tabs 132 and the v-shaped member 134 act together to create a restraining relationship with the washer 104 and the support member 144.

The screw 102 is connected to the washer 104 in a loose and adjustably restrained relationship by threading the screw 102 through the elongated slot 127 by a rotating action. The diameter of the helically threaded portion 118 and the configuration and the size of the elongated slot 127 are selected so that as the screw 102 can be driven through the elongated slot 127. In one example, the side members 128 and 129 flex relative to each other to allow the helically threaded portion 118 of the screw 102 to pass through the washer 104. In another example, the flexure of the side members 128 and 129 is facilitated by the channel 130 that allows relative motion of side members 128 and 129 with respect to each other along the channel 130.

After the threaded portion 118 passes through the elongated slot 127, the screw 102 is connected to the washer 104 in a loose and adjustable relationship because the diameter of the inner portion 116 of the screw 102 is smaller than the dimensions of the elongated slot 127 allowing the screw to float within a range of motion. The movement of the screw 102 is restrained in one direction when the base 112 contacts the flat portion 126 of the washer 104, and the shoulder 122 restrains the movement of the screw 102 in another opposite direction when the shoulder 122 contacts the flat portion 126 of the washer 104, thus defining a range of movement. Further, the elongated slot 127 allows the screw 102 to move in a lateral direction within the slot 127, thus defining another range of movement.

In one example of the apparatus 100, the tabs 132 assert a spring loaded flexing action against the support member 144 in conjunction with the action of the v-shape member 134 in contact with the support member 144 and establish a restraining relationship of the washer 104 with the support member 144.

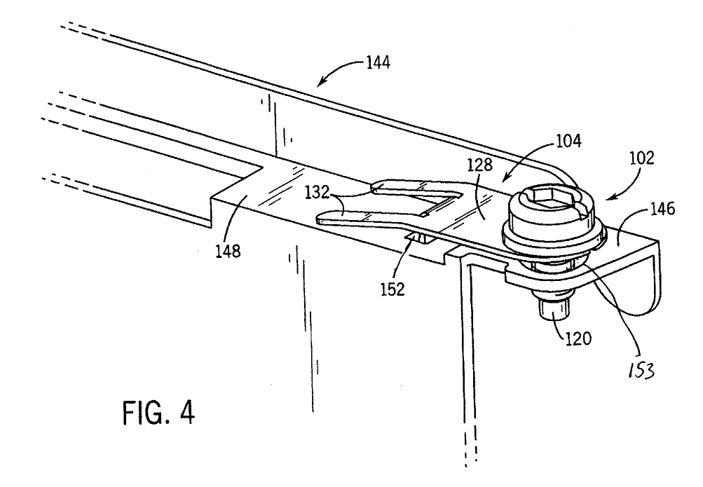

In FIGS. 4 and 5, the screw 102 and washer 104 are shown connected to a support member 144. The support member 144 has a first member 146 and a relatively lower second member 148 transitioned from the first flat surface by a step-connection 150. The support member 144 includes a slotted aperture 152 that is sized to receive the v-shaped member 134. The aperture 152 is sized so that the v-shaped member 134 can be received in the aperture in a captive relationship if the v-shaped member is first compressed by bringing the first portion 136 and second portion 138 together so that the v-shaped member 134 will pass through the aperture 152. For example, the compression can also be achieved by the contact of the first portion 136 and the second portion 138 by the contact with the slot 152 as they pass through the slot 152. After passing through the aperture 152, the compression is removed from the v-shaped member 134 either manually or by the removal of contact with the slot 152. The first portion 136 and the second portion 138 then return to the uncompressed position, and the v-shaped member 134 is then in a restrained relationship with the support member 144 as shown in FIG. 5. The washer 104 is further restrained by the restraining relationship of the tabs 132 with the second member 148 and the contact of an outer end 139 of the second portion 138 with the second member 148.

The action of the tabs 132 provides a force by a flexing action applied to the second member 148. This action restrains the end 139 of the second portion 138 of the v-shaped member 134 against the second member 148 of the support member 144. In another example, the tabs 132 flex to provide the spring like force and this enables a variation of support member to have a retraining relationship with the washer 104. For example, the washer 104 could be in a restraining relationship with a support member that did not have a step-connection 150 as does the support member 144.

The restraining action of the tabs 132 and the clip or v-shaped member 134 are able to accommodate variations in the shape of support members. In one example, the flexing action of the tabs 132 in combination with the v-shaped member 134 would be able to restrain the washer 104 to a support member that does not have a step-connection such as the step-connection 150 of support member 144. As would be understood by those skilled in the art, other variations in contours of support members could be accommodated as well.

The first member 146 has a receptacle or aperture 153 positioned and sized to receive the barrel portion 114 of the screw 102 without engaging or restraining the screw 102. The screw 102 is restrained in location by its contact with the flat portion 126 of the washer 104 and the restraining action of the tabs 132 and the v-shaped member 134 with the second member 148 of the support member 144.

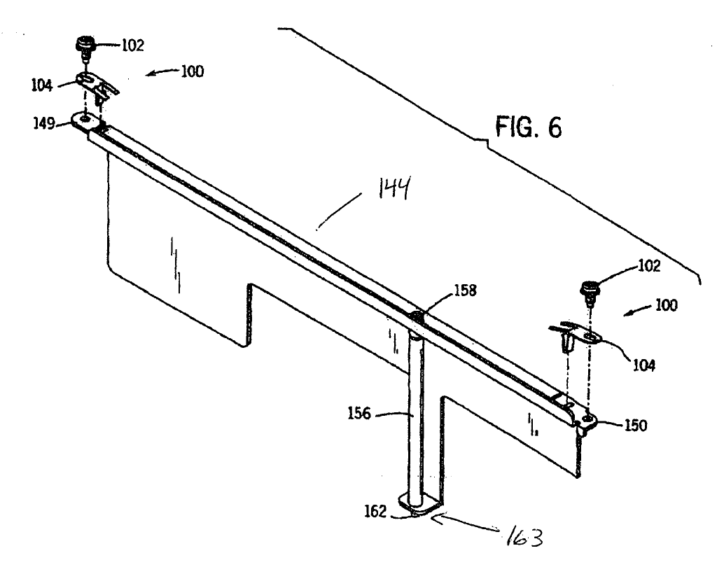

Referring to FIG. 6, an exploded view of an example of-the apparatus 100 and how it relates in assembly to the support member 144. The apparatus 100 is installed at opposed ends, 149 and 150, of the support member 144. A center support structure 156 is shown having a connecting screw 158 extending through a tubular passageway 160 with a threaded end 162 on the screw 158 extending beyond a lower end 163 of the tubular passageway 160.

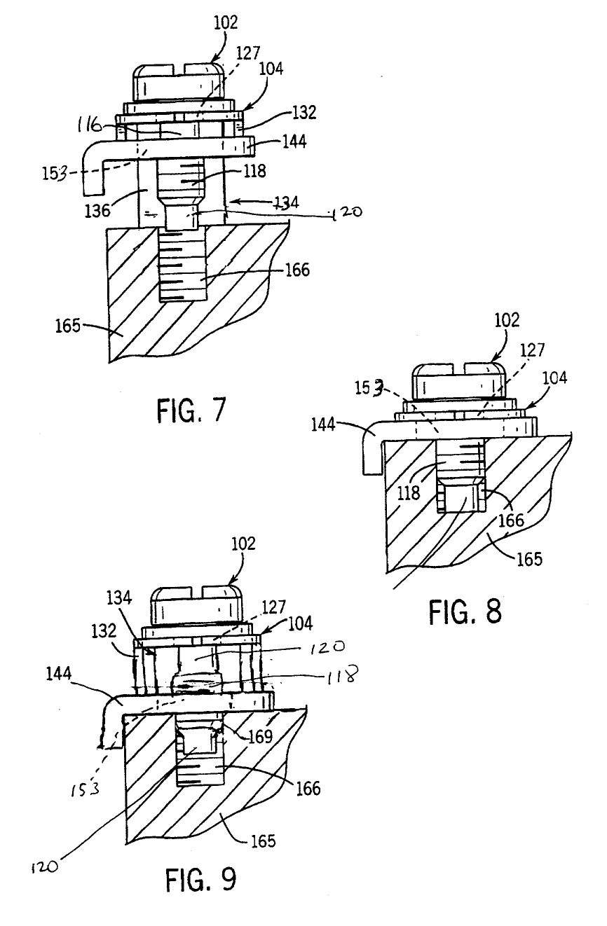

The apparatus 100 connects the support member 144 to a component 165. Referring to FIGS. 5 and 7, a force applied for example by a tool engaging the head 108 of the screw 102 will result in flexing of the flat portion 126 of the washer 104 and movement of the fastener or screw 102 toward the support member 144.

Referring to FIG. 7, The apparatus 100 is shown positioned in preparation for connecting the support member 144 to the component 165. The connection of the apparatus 100 can be made with the support member 144 prior to bringing the support member 144 to the component 165 for connection to the component 165. The apparatus 100 is shown with the fastener or screw 102 in a spaced or floating relationship above the support member 144. The screw extends through the elongated slot 128 in a restrained relationship with the washer 104. The screw 102 is also aligned with the receptacle or aperture 153 in the first member 146 of the support member 144. Adjustments in the position of the restrained screw 102 to better align the screw 102 with the aperture or a threaded channel 166 in the component 166 can be made by moving the screw 102 in the elongated slot 127.

The threaded channel 166 in the component 165 is sized to engage the threaded portion 118 of the screw 102. Using a tool apply a force to the head 108 of the fastener or screw 102 directed toward the support member 144, the flat portion 126 of the retainer or washer 104 flexes and the lead-in portion 120 of the screw 102 extends unobstructed and freely through the receptacle or aperture 153 of the support member 144 and then leads the threaded portion 118 of the screw 102 into the threaded aperture or channel 166. The screw is then rotated engaging the threads of the threaded portion 118 with the threads of the threaded channel 166. Since the threaded portion 118 of the screw 102 passes through the aperture 153 of the support member 144 without engaging a threaded washer in the support member 144, there does not exist the risk of binding and thread stripping as sometimes occurs where, as known in the art, adjacent and abutting threaded connections occur between support members and components. FIG. 8, shows the completed fastener process with the support member 144 secured to the component 165 by the apparatus 100.

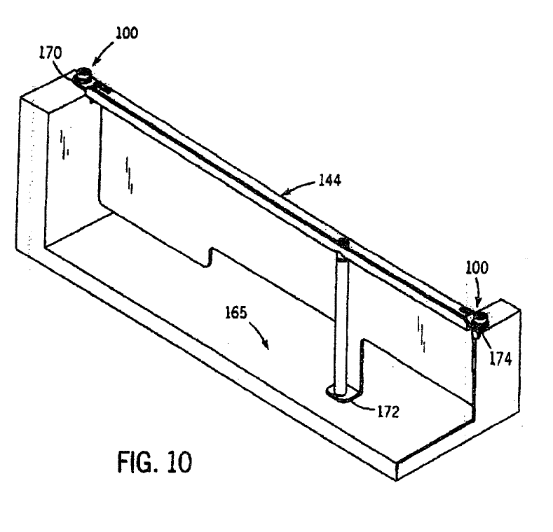

In FIG. 9, the fastener or screw 102 is shown in a partial threaded connection with the threaded aperture or channel 166. This state occurs when the screw is being rotated inwardly or outwardly of the threaded channel 166 and without engagement or obstruction through the receptacle or aperture 153. The support member 144 stays in an abutted relationship with the component 165 by virtue of the weight of the support member 144 resting on the component 165 which is the practice during assembly.

Referring to FIG. 10, the support member 144 is shown connected to the component 165 by the apparatus 100. There are three locations of connection 170, 172 and 174 between the support member 144 and the component 165. Allowing for the independent movement of the screw 102 relative to the support member 144, is more clearly appreciated when viewing the connection 170 and 174. At the connection 172, the threaded end 162 of the screw 158 is connected to the component 165. The independent motion of the screw 102 relative to the support member 144 can be more clearly appreciated. Without a threaded connection between the support member 144 and the screw 102, the screws 102 can be installed or removed completely and independently of each other. The need to resort to a procedure for assembly or disassembly is not required. Previously, such a procedure was required so that each screw be given a few rotations at a time to reduce the risk of binding of fasteners and stripping of threads. In the operation of the apparatus 100, there is no binding or stripping in the connections 170 and 174 between the adjacent support member 144 and the component 165.

The stripping of the threads is of particular concern due to metal shavings falling into the chassis and possibly shorting out electrical components such as chips, resistors, capacitors, and inductors, etc., and also damage to the assembly occurring when the screws lose the capacity to provide holding force.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus, comprising:
a fastener; and
a retainer having a portion in a restraining and adjustable relationship with the fastener and
wherein the retainer comprises a portion that has a restraining element extending from an end of the retainer to maintain the fastener in a location and upon a force applied to the fastener allows a flexing movement of the portion of the retainer and movement of fastener.

2. The apparatus of claim 1, wherein the fastener is received in a slot in the portion of the retainer, and
wherein the fastener comprises a head and a member that extends from the head, and
wherein the member extends through the slot in the portion of the retainer with the head and member restrained on opposite sides of the portion of the retainer.

3. The apparatus of claim 2, wherein the head has helical threads that engage the retainer as the head extends through the slot in the retainer.

4. The apparatus of claim 3, wherein the slot comprises a channel connecting the slot through an edge of the retainer, and wherein the channel facilitates the flexing of opposed sides of the slot for engagement of rotation of the helical threads of the head.

5. The apparatus of claim 2, wherein the restraining element comprises:
a first member, and
a clip, and
wherein the first member and the clip act together to restrain the retainer to a support member.

6. The apparatus of claim 5, wherein the first member is at least one tab engaging the support member and wherein the clip is received in a captive relationship by the support member.

7. The apparatus of claim 6, wherein a spring load action of the at least one tab engages the support member, and
wherein the clip comprises a v-shaped member having an end that engages the support member.

8. The apparatus of claim 7, wherein the engagement of the at least one tab and the v-shaped member with the support member is at a first elevation of the support member and the receptacle of the support member is at a second elevation of the support member.

9. The apparatus of claim 5, wherein the fastener is aligned in a spaced relationship with a receptacle in the support member.

10. The apparatus of claim 9, wherein the flexing movement provides for movement of the fastener toward the receptacle of the support member.

11. The apparatus of claim 10, wherein the flexing movement of the fastener provides for unobstructed movement of the fastener through the receptacle of the support member and connection with an aperture in a component.

12. The apparatus of claim 5, wherein the portion of the retainer comprises a slot for adjusting the fastener for axial alignment with the receptacle in the component.

13. The apparatus of claim 1, wherein the fastener is a screw and the retainer is a washer.

14. An apparatus, comprising:
a fastener comprising a first portion; and
a retainer comprising a portion having a slot in the portion, and
wherein the slot is sized to receive the first portion of the fastener in an interactive passage of the first portion through the slot and resisting the retraction of the first portion after the first portion is received by the slot; and
wherein the retainer further comprises a restraining element extending from an end of the retainer to maintain the fastener in a location and allows for flexing movement of the portion and movement of the fastener.

15. The apparatus of claim 14, wherein the fastener comprises a second portion and a connection portion connecting the first portion and the second portion, and
wherein upon the first portion passing through the slot the connection portion is disposed in the slot and the fastener is maintained in a restrained relationship with the retainer.

16. The apparatus of claim 15, comprises a channel connecting the slot through an edge of the portion in the retainer, and
wherein the first portion is threaded with helical threads; and
wherein during the interactive passage of the threaded first portion through the slot, the channel facilitates relative motion of opposed sides of the slot to enable passage of the threaded the first portion through slot.

17. The apparatus of claim 16, wherein force applied to the fastener results in the flexing of the portion of the retainer and movement of the fastener through a passageway in a support member and connection with an aperture in a component.

18. The apparatus of claim 16, wherein the fastener, the passageway and channel are axially aligned.

19. The apparatus of claim 14, wherein the fastener is a screw and the retainer is a washer.

20. An apparatus, comprising:
means for restraining a fastener to a retainer;
means for restraining the retainer to a support member;
means for flexing the retainer upon application of force on the fastener to move the fastener through the support member into an engagement with an aperture in a component; and
means for connecting the support member to the component with the fastener.

21. The apparatus of claim 20,
wherein means for connecting comprises means for adjusting the location of the fastener relative to the retainer and axially aligning the fastener, a passageway of the support and channel in the component; and
wherein means for restraining comprises means for making a threaded connection between the fastener and the retainer.

22. A method comprising, the steps of:
connecting a fastener to a retainer in a restrained relationship;
connecting the retainer to a support member; and
upon applying a force to the fastener, flexing the retainer to movement of the fastener from a position spaced from the support member toward an aperture in the support member axially aligned with the fastener.

23. The method of claim 22, comprising the steps of:
applying force to the fastener for moving the fastener through the aperture in the support member; and
after moving through the aperture in the support member, connecting the fastener to a component.

24. The method of claim 23, wherein the fastener and the component connected in a threaded connection.
